(19) United States
(12) Patent Application Publication
(10) Pub. No.: US 2009/0002609 A1
(43) Pub. Date: Jan. 1, 2009

(54) LIQUID CRYSTAL DISPLAY DEVICE

(76) Inventors: Mitsutaka Okita, Hakusan-shi (JP); Kazuhiro Nishiyama, Kanazawa-shi (JP); Shigesumi Araki, Kanazawa-shi (JP); Emi Higano, Ishikawa-gun (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/121,381

(22) Filed: May 15, 2008

(30) Foreign Application Priority Data
May 18, 2007 (JP) 2007-132836
May 18, 2007 (JP) 2007-132837
May 13, 2008 (JP) 2008-125469

(51) Int. Cl. G02F 1/1335

(52) U.S. Cl. 349/98

(57) ABSTRACT

A liquid crystal display device having a reflective part and a transmissive part in each of a plurality of pixels which are arrayed in a matrix, includes a liquid crystal display panel which is configured such that a liquid crystal layer is held between a pair of substrates, and to which an OCB mode is applied, and a pair of optical elements which are disposed on outer surfaces of the liquid crystal display panel, respectively, and optically compensate a retardation of the liquid crystal layer in a predetermined display state in which a voltage is applied to the liquid crystal layer, wherein the optical element is configured to include a circular polarization element including a polarizer and a first retardation plate which is disposed between the polarizer and the liquid crystal display panel and imparts a retardation of 1/4 wavelength, and a second retardation plate which is disposed between the circular polarization element and the liquid crystal layer, and has refractive index anisotropy with a major axis being inclined to a normal line, and the optical element has a retardation in a thickness direction thereof.

### CROSS-REFERENCE TO RELATED APPLICATIONS

This application is based upon and claims the benefit of priority from prior Japanese Patent Applications No. 2007-132836, filed May 18, 2007; No. 2007-132837, filed May 18, 2007; and No. 2008-125469, filed May 13, 2008, the entire contents of all of which are incorporated herein by reference.

### BACKGROUND OF THE INVENTION

1. Field of the Invention

The present invention relates to a liquid crystal display device, and more particularly to a transflective liquid crystal display device using an optically compensated bend (OCB) alignment technique which can realize an increase in viewing angle and an increase in response speed.

2. Description of the Related Art

Liquid crystal display devices have been applied to various fields by taking advantage of their features such as light weight, small thickness and low power consumption.

In recent years, attention has been paid to a liquid crystal display, to which the OCB mode is applied, as a liquid crystal display device which can improve the viewing angle and response speed. The OCB mode liquid crystal display device is configured such that a liquid crystal layer including liquid crystal molecules, which are bend-aligned in a state in which a predetermined voltage is applied, is held between a pair of substrates. Compared to a twisted nematic (TN) mode, the OCB mode is advantageous in that the response speed can be increased and the viewing angle can be increased since the effect of birefringence of light, which passes through the liquid crystal layer, can optically be compensated by the alignment state of liquid crystal molecules.

In addition, in recent years, a transflective liquid crystal display device having a reflective part and a transmissive part, to which the OCB mode is applied, has been developed. Jpn. Pat. Appln. KOKAI Publication No. 2005-164957, for instance, discloses a circular polarizer which is applicable to an OCB mode transflective liquid crystal display device. This circular polarizer is configured to include a polarizer and a liquid crystal film as an optical anisotropic element in which a nematic hybrid alignment structure is fixed.

At present, however, the optimization of a circular polarizer, which is applied in a case where an optical design peculiar to the OCB mode is made, has not sufficiently been discussed. In particular, there is such a problem that a viewing angle, at which a high contrast ratio (e.g. CR=10:1, or more) is obtained when transmissive display is performed, is narrow.

### BRIEF SUMMARY OF THE INVENTION

The object of the present invention is to provide a transflective liquid crystal display device which can realize a wide viewing angle and to which an OCB mode is applied.

According to an aspect of the present invention, there is provided a liquid crystal display device having a reflective part and a transmissive part in each of a plurality of pixels which are arrayed in a matrix, comprising: liquid crystal display panel which is configured such that a liquid crystal layer is held between a pair of substrates, and to which an OCB mode is applied; and a pair of optical elements which are disposed on outer surfaces of the liquid crystal display panel, respectively, and optically compensate a retardation of the liquid crystal layer in a predetermined display state in which a voltage is applied to the liquid crystal layer, wherein the optical element is configured to include: a circular polarization element including a polarizer and a first retardation plate which is disposed between the polarizer and the liquid crystal display panel and imparts a retardation of ¼ wavelength; and a second retardation plate which is disposed between the circular polarization element and the liquid crystal layer, and has refractive index anisotropy with a major axis being inclined to a normal line, and the optical element has a retardation in a thickness direction thereof.

The present invention can provide a transflective liquid crystal display device which can realize a wide viewing angle and to which an OCB mode is applied.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view that schematically shows the structure of a liquid crystal display device according to an embodiment of the present invention;

FIG. 2 is a view that schematically shows the structure of a liquid crystal display panel which is applicable to the liquid crystal display device shown in FIG. 1;

FIG. 3 is a view that schematically shows the structure of an OCB mode transflective liquid crystal display panel which is applicable to the liquid crystal display device shown in FIG. 1;

FIG. 4 is a view for explaining the relationship of alignment film capacitance and liquid crystal capacitance between a reflective part and a transmissive part;

FIG. 5 is a view for explaining the definitions of axis angles to a rubbing direction of an alignment film in the liquid crystal display device shown in FIG. 1;

FIG. 6 is a view for describing a structure example of a liquid crystal display device according to a first embodiment;

FIG. 7 is a view showing a simulation result of the viewing angle dependency of a contrast ratio at a time of transmissive display in the liquid crystal display device according to the first embodiment;

FIG. 8 is a view that schematically shows the structure of a liquid crystal display device according to a second embodiment;

FIG. 9 is a view for describing a structure example of the liquid crystal display device according to the second embodiment;

FIG. 10 is a view showing a simulation result of the viewing angle dependency of a contrast ratio at a time of transmissive display in the liquid crystal display device according to the second embodiment;

FIG. 11 is a view for describing a structure example of a liquid crystal display device according to a third embodiment;

FIG. 12 is a view that schematically shows the structure of a liquid crystal display device according to a fourth embodiment;

FIG. 13 is a view for describing a structure example of the liquid crystal display device according to the fourth embodiment;

FIG. 14 is a view that schematically shows the structure of a liquid crystal display device according to a fifth embodiment; and

FIG. 15 is a view for describing a structure example of the liquid crystal display device according to the fifth embodiment.

### DETAILED DESCRIPTION OF THE INVENTION

A liquid crystal display device according to an embodiment of the invention will now be described with reference to the accompanying drawings. A description is given of, as an example of the liquid crystal display device, a transflective liquid crystal display device to which an OCB mode is applied and which is configured to include, in each of pixels, a transmissive part that displays an image by selectively transmitting the light from the backlight and a reflective display part that displays an image by selectively reflecting ambient light.

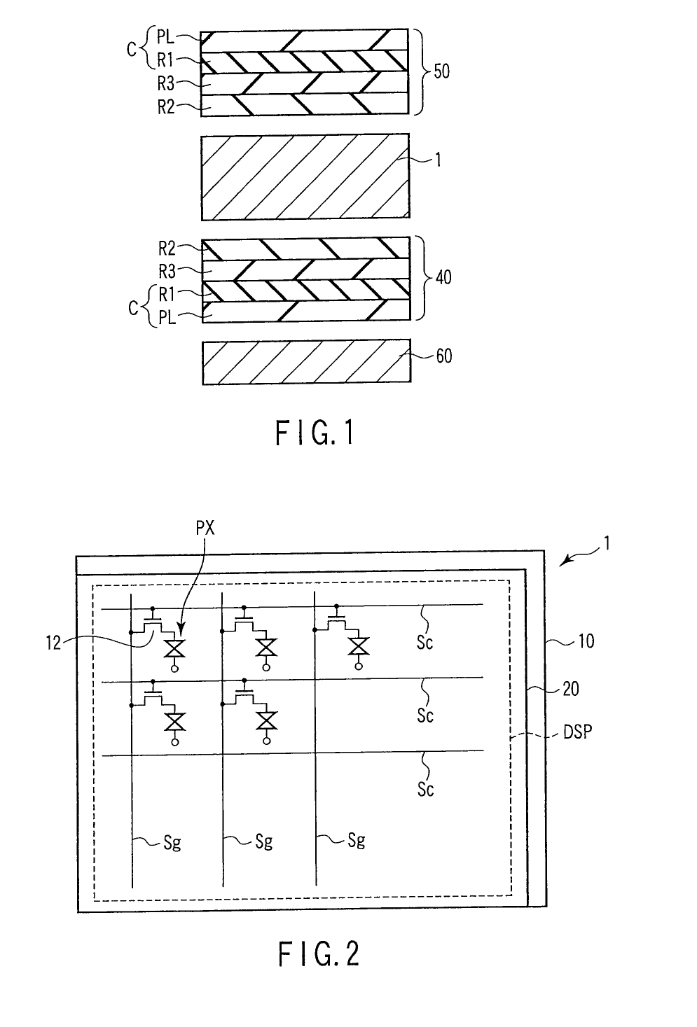

As shown in FIG. 1, the liquid crystal display device is configured to include a liquid crystal display panel 1 to which an OCB mode is applied, and a pair of optical elements, namely, a first optical element 40 and a second optical element 50, which are disposed on both outer surfaces of the liquid crystal display panel 1. The liquid crystal display includes a backlight 60 that illuminates the liquid crystal display panel 1 from the first optical element 40 side. Specifically, the first optical element 40 is disposed between the liquid crystal display panel 1 and the backlight 60.

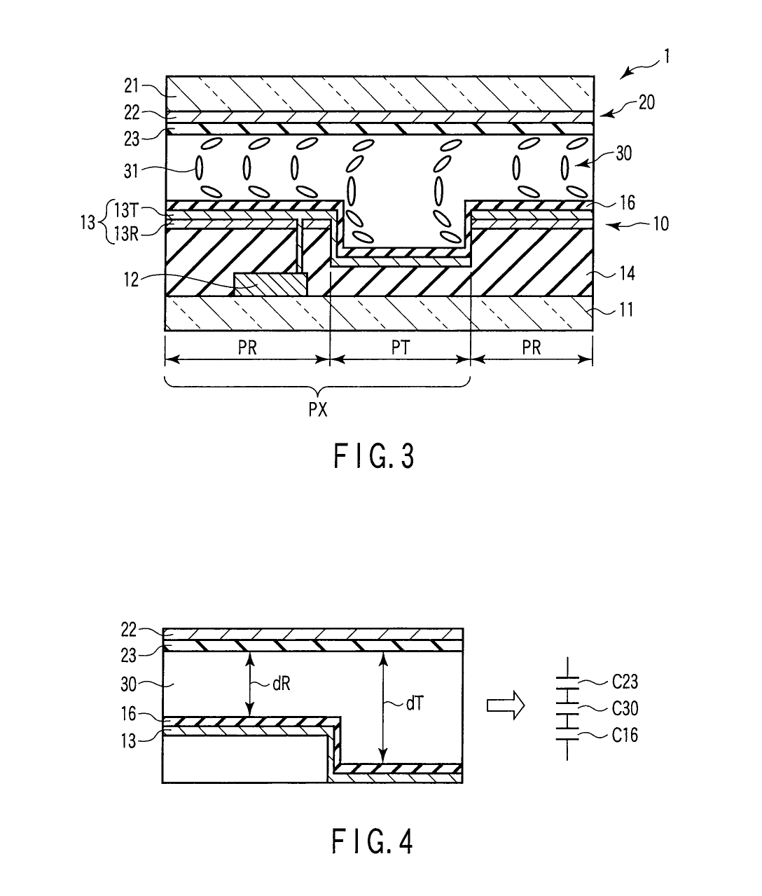

As shown in FIG. 2 and FIG. 3, the liquid crystal display panel 1 is configured such that a liquid crystal layer 30 is held between a pair of substrates, namely, an array substrate (a substrate opposed to the first optical element 40) 10 and a counter-substrate (a substrate opposed to the second optical element 50, or an observation-side substrate) 20, and the liquid crystal display panel 1 includes an active area DSP that displays an image. The active area DSP has a substantially rectangular shape and is composed of a plurality of pixels PX which are arrayed in a matrix.

Each of the pixels PX includes a reflective part PR that displays an image by selectively reflecting ambient light in a reflective display mode, and a transmissive part PT that displays an image by selectively transmitting the light from the backlight 60 in a transmissive display mode.

The array substrate 10 is formed by using a light-transmissive insulating substrate 11 of, e.g. glass. The array substrate 10 includes, on one major surface of the insulating substrate 11, that is, on a surface thereof facing the liquid crystal layer 30, a plurality of scanning lines Sc which are disposed in a manner to extend along a row direction of the pixels PX; a plurality of signal lines Sg which are disposed in a manner to extend along a column direction of the pixels PX; switch elements 12 are disposed in association with the respective pixels PX near intersections between the scanning lines Sc and signals lines Sg; pixel electrodes 13 which are connected to the switch elements 12 and are disposed in association with the respective pixels PX; and an alignment film 16 which is disposed in a manner to cover the pixel electrodes 13.

The scanning lines Sc and signal lines Sg are disposed so as to cross each other via an insulation film.

The switch element 12 is composed of, e.g. a thin-film transistor (TFT). The switch element 12 includes a semiconductor layer which is formed of, e.g. polysilicon or amorphous silicon. The gate of the switch element 12 is electrically connected to the associated scanning line Sc (or formed integral with the associated scanning line). The source of the switch element 12 is electrically connected to the associated signal line Sg (or formed integral with the associated signal line).

The pixel electrode 13 is disposed on an insulation film 14. The insulation film 14 forms a gap difference of the liquid crystal layer 3 between the reflective part PR and the transmissive part PT. Each of the pixel electrodes 13 includes a reflective electrode 13R which is provided in association with the reflective part PR, and a transmissive electrode 13T which is provided in association with the transmissive part PT. The reflective electrode 13R is formed of a light-reflective electrically conductive material such as aluminum. The transmissive electrode 13T is formed of a light-transmissive electrically conductive material such as indium tin oxide (ITO). The reflective electrode 13R and transmissive electrode 13T are electrically connected to the drain of the switch element 12.

The counter-substrate 20 is formed by using a light-transmissive insulating substrate 21 of, e.g. glass. The counter-substrate 20 includes a counter-electrode 22 which is disposed on one major surface of the insulating substrate 21, that is, a surface thereof facing the liquid crystal layer 30, so as to be opposed to the pixel electrodes 13 of the plural pixels PX, and an alignment film 23 which is disposed so as to cover the counter-electrode 22. The counter-electrode 22 is formed of a light-transmissive electrically conductive material such as ITO.

The array substrate 10 and counter-substrate 20 having the above-described structures are disposed with a predetermined gap therebetween via a spacer not shown (e.g. a columnar spacer which is integrally formed on one of the substrates) in such a manner that their alignment films 16 and 23 are opposed to each other, and are attached to each other by a sealant. The liquid crystal layer 30 is sealed in the gap between the array substrate 10 and counter-substrate 20.

In this embodiment, the liquid crystal display panel 1 is configured such that an OCB mode is applied to the liquid crystal display panel 1. The liquid crystal layer 30 is formed of a liquid crystal material including liquid crystal molecules 31 which have positive dielectric constant anisotropy and optically positive uniaxiality. In this liquid crystal layer 30, in a predetermined display state in which a voltage is applied to the liquid crystal layer 30, the liquid crystal molecules 31 are bend-aligned between the array substrate 10 and counter-substrate 20. In the example shown in FIG. 3, the liquid crystal molecules 31 are bend-aligned in the transmissive part PT and reflective part PR.

In particular, in the liquid crystal display panel 1 to which the OCB mode is applied, as shown in FIG. 4, a cell gap dR in the reflective part PR is set to be less than ½ of a cell gap dT of the transmissive part, that is,

dR<dT/2.

The cell gap, in this context, substantially corresponds to the thickness of the liquid crystal layer 30 between the alignment film 16 of the array substrate 10 and the alignment film 23 of the counter-substrate 20.

Specifically, both the alignment film and liquid crystal layer are dielectric bodies which are disposed between the pixel electrode 13 and the counter-electrode 22. A liquid crystal material, which is applied to the OCB mode, has a relatively high specific dielectric constant (ε) that is, e.g. 14 or more. When a voltage is applied between the pixel electrode 13 and the counter-electrode 22 so that a predetermined voltage is applied to the liquid crystal layer of the transmissive part PT, the degree of contribution of a capacitance C16 of the alignment film 16 and a capacitance C23 of the alignment film 23 to a capacitance C30 of the liquid crystal layer 30 is high, and thus a necessary and sufficient voltage cannot be applied to the liquid crystal layer 30 of the reflective part PR in the case where the cell gap dR of the reflective part PR is set at ½ of the cell gap dT of the transmissive part PT. It is necessary, therefore, to set the cell gap dR of the reflective part PR to be less than ½ of the cell gap dT of the transmissive part PT, and to increase the ratio of the voltage that is applied to the liquid crystal layer 30 of the reflective part PR. In short, the cell gap dR of the reflective part PR is set at such a value that a sufficient voltage can be applied to the liquid crystal layer 30 of the reflective part PR.

In this embodiment, the cell gap dT of the transmissive part PT is 4.65 μm, and the cell gap dR of the reflective part PR is 2.1 μm, which is less than ½ of the cell gap dT.

### First Embodiment

To begin with, a liquid crystal display device according to a first embodiment is described. In the first embodiment, the first optical element 40 and second optical element 50 have a function of optically compensating the retardation of the liquid crystal layer 30 in a predetermined display state in which a voltage is applied to the liquid crystal layer 30 in the above-described liquid crystal display panel 1. The first optical element 40 and second optical element 50 are configured to have retardation in their thickness direction.

As shown in FIG. 1, the first optical element 40 is disposed on the outer surface of the array substrate 10, and the second optical element 50 is disposed on the outer surface of the counter-substrate 20. The first optical element 40 and second optical element 50 have the same structure. Specifically, each of the first optical element 40 and second optical element 50 is configured to include a circular polarization element C including a polarizer PL and a first retardation plate R1; a second retardation plate R2; and a third retardation plate R3. The first optical element 40 and second optical element 50 are configured to be symmetric with respect to the liquid crystal display panel 1. Specifically, in each of the first optical element 40 and second optical element 50, the second retardation plate R2, third retardation plate R3, first retardation plate R1 and polarizer PL are stacked in the named order from the liquid crystal display panel 1 side.

The polarizer PL is configured such that a polarizing layer, which is formed of, e.g. polyvinyl alcohol (PVA), is held between a pair of support layers which are formed of, e.g. triacetylcellulose (TAC). The polarizer PL has, in its plane, a transmission axis and an absorption axis which are substantially perpendicular to each other.

The first retardation plate R1 is disposed between the polarizer PL and the liquid crystal display panel 1, and has, in its plane, a fast axis and a slow axis which are substantially perpendicular to each other. The first retardation plate R1 is a so-called ¼ wavelength plate which imparts a retardation of ¼ wavelength between light components of a predetermined wavelength (e.g. light having a wavelength of 550 nm) which pass through the fast axis and the slow axis. The combination of the polarizer PL and the first retardation plate (¼ wavelength plate) R1 ideally functions as a circular polarizer which converts linearly polarized light of a predetermined wavelength, which has passed through the transmission axis of the polarizer PL, to circularly polarized light.

The second retardation plate R2 is disposed between the circular polarization element C and the liquid crystal display panel 1, and has, in its plane, a fast axis and a slow axis which are substantially perpendicular to each other. The second retardation plate R2 is an anisotropic film which compensates the retardation of the liquid crystal layer 30, and is an anisotropic film having a refractive index anisotropy with its substantial major axis being inclined to the normal line when consideration is given to the comprehensive refractive index anisotropy of the second retardation plate R2 itself. A WV (wide view) film (manufactured by FUJIFILM Corporation), for instance, is applicable as the second retardation plate R2. The WV film is a liquid crystal film in which discotic liquid crystal molecules having optically negative uniaxial refractive index anisotropy are fixed in the state in which the optical axis is hybrid-aligned (i.e. major axis is hybrid-aligned) along the normal direction (i.e. the thickness direction of the retardation plate) in the liquid crystal state. The second retardation plate R2 is a retardation plate corresponding to an A-plate having retardation in its plane, and optically compensates the viewing angle dependency based on the refractive index anisotropy of bend-aligned liquid crystal molecules.

The third retardation plate R3 is disposed between the circular polarization element C and the second retardation plate R2, and is a retardation plate corresponding to a C-plate having retardation in its thickness direction. Specifically, the third retardation plate R3 has a refractive index anisotropy of nx=ny>nz (optically negative), where nx and ny are refractive indices in mutually perpendicular directions in its plane, and nz is a refractive index in its normal direction. In short, in the first embodiment, the retardation in the thickness direction of the optical element is provided by the third retardation plate R3. To be more specific, the third retardation plate R3 compensates deficiency of the refractive index (nz) in the thickness direction which is necessary for optical compensation by the second retardation plate R2.

In the above-described liquid crystal display device, the respective structural parts are disposed, for example, with the following axis angles, with the rubbing direction of the alignment film 16 of the array substrate 10 and the alignment film 23 of the counter-substrate 20 being set as a reference direction. The axis angles are angles of the absorption axis of the polarizer and the slow axis of the retardation plate, which are formed counterclockwise relative to the reference direction (X axis), and are defined in FIG. 5. Specifically, when the liquid crystal display device is observed from the counter-substrate 20 side, an X axis and a Y axis, which are perpendicular to each other, are defined, for the purpose of convenience, in a plane that is parallel to the major surface of the array substrate 10 (or counter-substrate 20), and a normal direction to this plane is defined as a Z axis. The term “in a plane” means “in an X-Y plane” which is defined by the X axis and Y axis. The rubbing direction of the alignment film 16 and alignment film 23 is parallel to the X axis, and the liquid crystal molecules 31 of the liquid crystal layer 30 are bend-aligned in the X-Z plane.

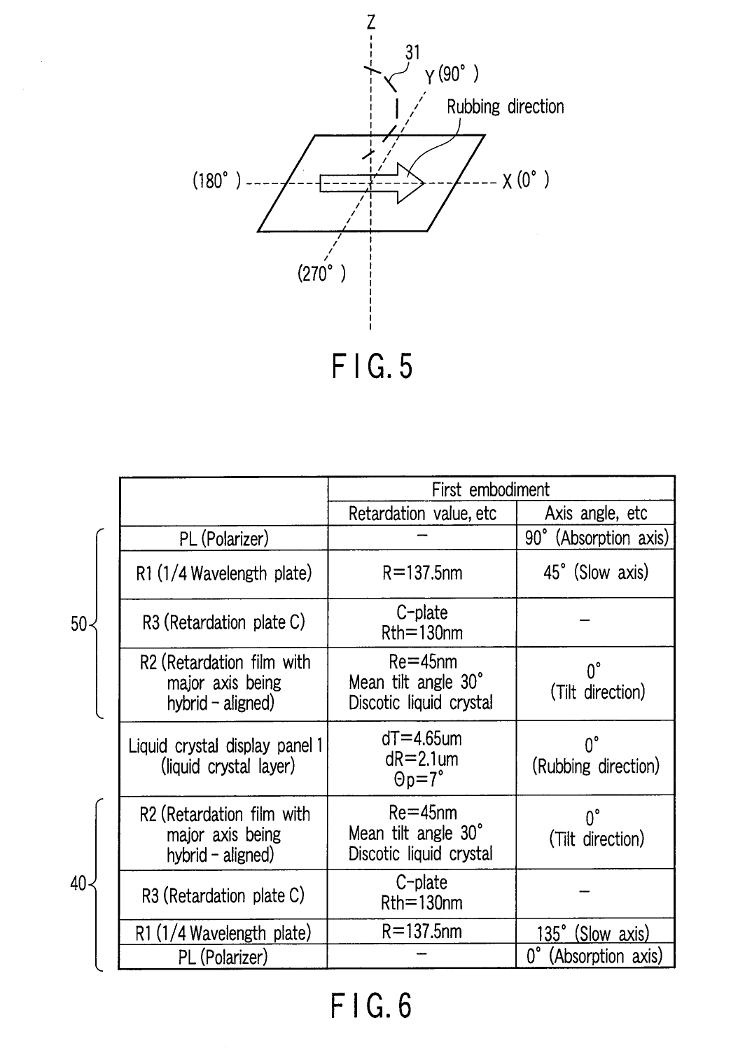

FIG. 6 shows a structure example of the first embodiment.

Specifically, in the liquid crystal panel 1, the rubbing direction of the liquid crystal layer 30 is set at 0° azimuth. In each pixel PX, the cell gap dT of the transmissive part PT is set at 4.65 μm, and the cell gap dR of the reflective part PR is set at 2.1 82 m. A pre-tilt angle Θp of the liquid crystal molecules in the liquid crystal layer 30 is set at 7°.

In the array substrate-side first optical element 40, the polarizer PL is disposed such that its absorption axis is set at 0° azimuth. The first retardation plate R1 is disposed such that its slow axis is set at 135° azimuth. The second retardation plate R2 is a retardation plate in which discotic liquid crystal molecules are hybrid-aligned in its thickness direction, and a mean tilt angle of the major axis of the discotic liquid crystal molecule is set at 30° to the normal line. The second retardation plate R2 is disposed such that the comprehensive orthogonal projection of the major axis on the X-Y plane is parallel to the rubbing direction. In short, the tilt angle of the major axis of the second retardation plate R2 is set at 0° azimuth.

In the counter-substrate-side second optical element 50, the polarizer PL is disposed such that its absorption axis is set at 90° azimuth. The first retardation plate R1 is disposed such that its slow axis is set at 45° azimuth. The second retardation plate R2 is disposed such that the tilt angle of its major axis is set at 0° azimuth.

As described above, in the first embodiment, in particular, each of the slow axes of the first retardation plates R1 of the first optical element 40 and second optical element 50 is set at 45° to the rubbing direction, and both slow axes are disposed to be perpendicular to each other. Thereby, the effect of wavelength dispersion of the first retardation plate R1 itself can be relaxed. In particular, it becomes possible to suppress a decrease in contrast due to the wavelength dependency when the liquid crystal display device is observed from the front (the normal direction of the liquid crystal display panel).

In addition, each of the polarizers PL, which are included in the first optical element 40 and second optical element 50, is disposed such that the absorption axis thereof is set at 45° to the slow axis of the first retardation plate R1 that constitutes the circular polarization element, and that the absorption axes of both polarizers PL are perpendicular to each other.

The retardation values of the respective structural parts of the first optical element 40 and second optical element 50 are as follows. In this case, the retardation values at the wavelength of 550 nm are indicated. Specifically, the retardation R of the first retardation plate R1 is 137.5 nm, the retardation (in-plane retardation) Re of the second retardation plate R2 is 45 nm, and the retardation (retardation in thickness direction) Rth of the third retardation plate R3 is 130 nm. In this case, the retardation values are set to be equal between the first optical element 40 and the second optical element 50 which are disposed via the liquid crystal layer 30, but in the present invention these retardation values may not be equal.

According to the above-described first embodiment, in the OCB mode transflective liquid crystal display device which has the function of effecting reflective display by the reflective part and transmissive display by the transmissive part, the comprehensive optical design of the optical element, which includes the circular polarization element C, and the OCB mode liquid crystal display panel is optimized, display with a high contrast ratio can be realized both in reflective display and transmissive display in the case of not only observation in a frontal direction but also observation in an oblique direction, and the viewing angle, at which the high contrast ratio can be obtained, can be increased.

Next, the advantageous effects of the above-described structure example of the first embodiment were verified.

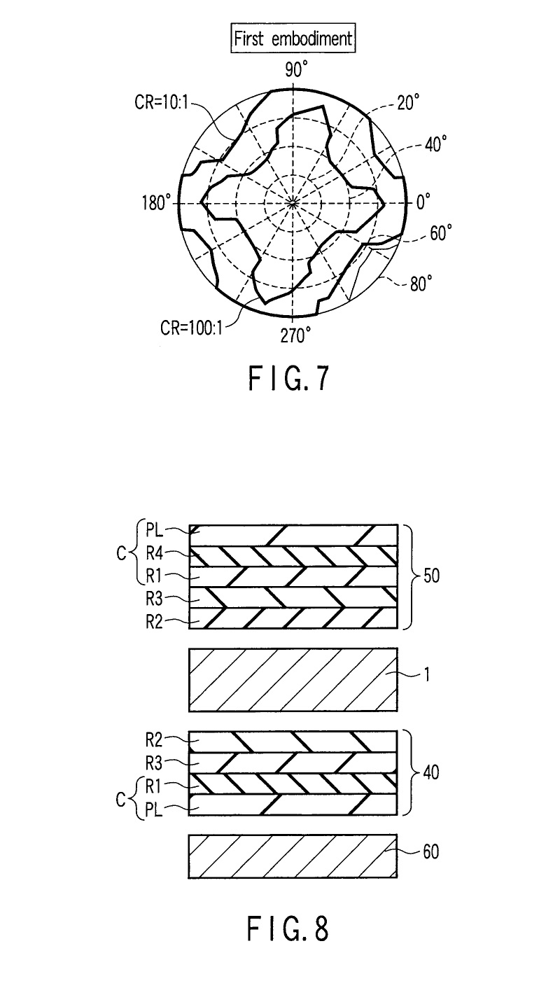

FIG. 7 shows a simulation result of the viewing angle dependency of the contrast ratio in the transmissive display in the liquid crystal display device according to the first embodiment. The center of concentric circles corresponds to the normal direction (Z axis) of the liquid crystal display panel. The concentric circles defined about the normal direction indicate tilt angles (viewing angles) to the normal direction, and correspond to 20°, 40°, 60° and 80°, respectively. The characteristic diagram, which is shown here, is obtained by connecting regions of equal contrast ratios (CR) in respective directions. In particular, the regions with the contact ratio=100:1 and the contact ratio=10:1 are illustrated.

As shown in FIG. 7. according to the structure example of the first embodiment, the contrast ratio=10:1 is obtained in the range of the viewing angles of 60° or more in all azimuth directions of the screen, and the contrast ratio=10:1 is obtained in the range of the viewing angles of 80° or more in azimuth directions of 0°-180° and 90°-270°. It was thus confirmed that sufficient viewing angles can be obtained.

### Second Embodiment

Next, a liquid crystal display device according to a second embodiment is described. In the second embodiment, like the first embodiment, the first optical element 40 and second optical element 50 have a function of optically compensating the retardation of the liquid crystal layer 30 in a predetermined display state in which a voltage is applied to the liquid crystal layer 30 in the above-described liquid crystal display panel 1. In particular, in the second embodiment, the circular polarization element C, which is provided in one of the first optical element 40 and second optical element 50, includes a fourth retardation plate R4 which is disposed between the polarizer PL and the first retardation plate R1. Thus, the first optical element 40 and second optical element 50 are asymmetric with respect to the liquid crystal display panel 1.

In an example shown in FIG. 8, the circular polarization element C of the second optical element 50, which is disposed on the counter-substrate 20 side (i.e. observation surface side) of the liquid crystal display panel 1, includes the polarizer PL, fourth retardation plate R4 and first retardation plate R1. However, the circular polarization element C of the first optical element 40 may include the fourth retardation plate R4. The other structure of the second embodiment is the same as that of the first embodiment.

The fourth retardation plate R4 has a fast axis and a slow axis which are substantially perpendicular to each other, and is a so-called ½ wavelength plate which imparts a retardation of ½ wavelength between light components of a predetermined wavelength (e.g. light having a wavelength of 550 nm) which pass through the fast axis and the slow axis. The fourth retardation plate R4 has a function of compensating the viewing angle dependency of the retardation of the entire liquid crystal display device, and increasing the viewing angle. In particular, the fourth retardation plate R4 is configured to mainly compensate the viewing angle dependency of the retardation of the ¼ wavelength plate (first retardation plate R1) of the circular polarization element C, which is needed in the OCB mode transflective liquid crystal display device.

Specifically, in the above-described first embodiment, in particular, when transmissive display is performed, good display with a high contrast is observed in the frontal direction. The reason is that the first retardation plate R1 functions as the ¼ wavelength plate which imparts a retardation of ¼ wavelength to the light passing therethrough, and the first retardation plate R1 is optically designed to produce ideal circular polarization light in combination with the polarizer PL.

However, when transmissive display is executed, the viewing angle, at which a high contrast ratio is obtained, is limited in the case where observation is performed in an oblique direction. In the example shown in FIG. 7, the viewing angle is narrower in the in azimuth directions of 45°-225° and 135°-315°, than in azimuth directions of 0°-180° and 90°-270°. The reason is mainly that the function of the ¼ wavelength plate is not obtained at a viewing angle in a certain azimuth direction owing to the viewing angle dependency of the retardation that is possessed by the first retardation plate R1 (i.e. the first retardation plate R1 is unable to impart the retardation of ¼ wavelength to the light passing therethrough). Thus, at a viewing angle in a certain azimuth direction, ideal circular polarized light cannot be produced by the combination of the first retardation plate R1 and the polarizer plate PL, and high-contrast display cannot be obtained.

Only the viewing angle dependency of the first retardation plate R1 has been described here. However, there is a case in which other structural parts have viewing angle dependency. These complex factors are thinkable, which cause a decrease in viewing angle, as in the example shown in FIG. 7.

Thus, in the second embodiment, the fourth retardation plate R4 is disposed so that such a retardation may be imparted as to achieve polarization close to ideal circular polarization even in the case where observation is performed in an oblique direction, thereby to compensate the viewing angle dependency of the retardation of not only the first retardation plate R1 but also the entire liquid crystal display device. Thereby, the viewing angle, at which a high contrast ratio can be obtained, can be made wider than in the first embodiment.

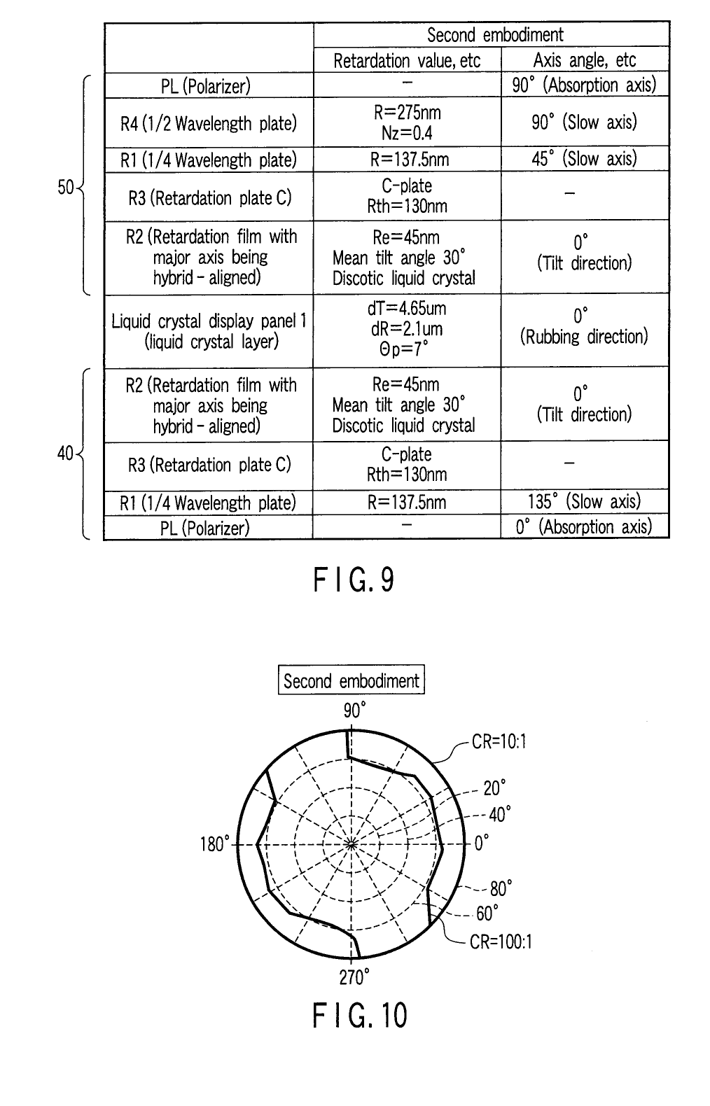

FIG. 9 shows a structure example of the second embodiment. The structure, other than the fourth retardation plate R4, is the same as the structure example of the first embodiment shown in FIG. 6.

In this structure example, the fourth retardation plate R4, which has biaxial refractive index anisotropy, is applied. Specifically, the fourth retardation plate R4 has refractive index anisotropy of nx>ny>nz. In the second optical element 50, the fourth retardation plate R4 is disposed such that its slow axis is set at 90° azimuth. In short, the slow axis of the fourth retardation plate R4 is set to be parallel to the absorption axis of the polarizer PL.

Thus, in the frontal direction, there is no influence of the retardation of the fourth retardation plate R4, and good display with a high contrast is observed as in the first embodiment. In the case where observation is performed in an oblique direction, the retardation, which is possessed by the fourth retardation plate R4, effectively functions, the viewing angle dependency of the retardation of the entire liquid crystal display device can be compensated, and polarization close to ideal circular polarization can be achieved. Therefore, good display with a high contrast can be observed in a wide range of viewing angles.

The retardation values of the respective structural parts of the first optical element 40 and second optical element 50 are as shown in FIG. 9. Like the first embodiment, the retardation values at the wavelength of 550 nm are shown. The fourth retardation plate R4 has a retardation R of 275 nm, and an Nz coefficient, which is given by Nz=(nx−nz)/(nx−ny), is set at 0.4.

Preferably, the Nz coefficient of the fourth retardation plate R4 should be set at 0.3 or more, in particular, in order to impart such a retardation as to achieve polarization close to ideal circular polarization also with respect to viewing angles of 60° or more in the azimuth directions of 45°-225° and 135°-315°. In addition, in order to prevent over-compensation which causes polarization exceeding the ideal circular polarization, it is preferable to set the Nz coefficient of the fourth retardation plate R4 at 0.6 or less.

According to the above-described second embodiment, in the OCB mode transflective liquid crystal display device which has the function of effecting reflective display by the reflective part and transmissive display by the transmissive part, the comprehensive optical design of the optical element, which includes the circular polarization element, and the OCB mode liquid crystal display panel is optimized, display with a high contrast ratio can be realized both in reflective display and transmissive display in the case of not only observation in a frontal direction but also observation in an oblique direction, and the viewing angle, at which the high contrast ratio can be obtained, can further be increased.

Next, the advantageous effects of the above-described structure example of the second embodiment were verified.

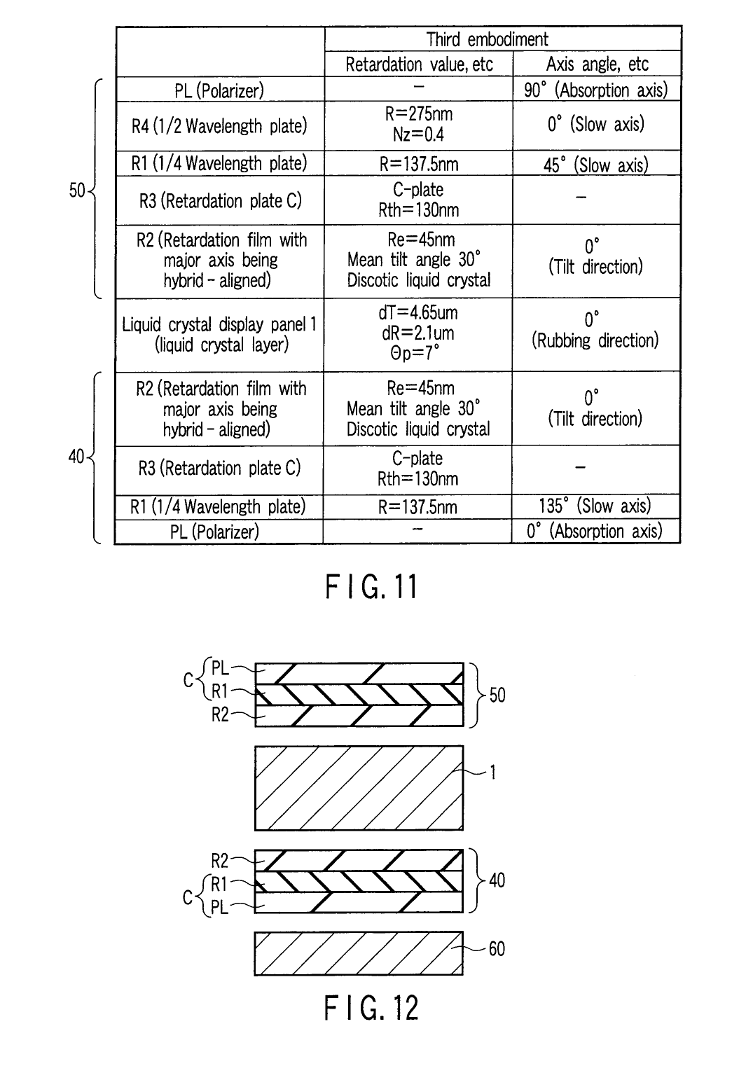

FIG. 10 shows a simulation result of the viewing angle dependency of the contrast ratio in the transmissive display in the liquid crystal display device according to the second embodiment. According to the structure example of the second embodiment, the contrast ratio=10:1, or more, is obtained in the range of viewing angles of 80° or more in all azimuth directions of the screen, and it was confirmed that sufficient viewing angles can be obtained. Compared to the first embodiment, the area of the viewing angles with the contrast ratio=10:1 or more was increased 1.14 times.

In the above-described second embodiment, since the fourth retardation plate R4 is disposed in the second optical element 50 on the counter-substrate 20 side (observation side), the fourth retardation plate R4 functions not only in the transmissive display but also in reflective display. However, there is no particular influence on the characteristics in the reflective display. In order to make the fourth retardation plate R4 effectively function in only the transmissive display, it is preferable to dispose the fourth retardation plate R4 between the polarizer PL and the first retardation plate R1, which constitute the circular polarization element C, in the first optical element 40 on the array substrate 10 side (the light incidence side/backlight side).

### Third Embodiment

Next, a liquid crystal display device according to a third embodiment is described. In the third embodiment, the fourth retardation plate R4, which has biaxial refractive index anisotropy, is applied. Specifically, the fourth retardation plate R4 has refractive index anisotropy of nx>ny>nz. In the second optical element 50, the fourth retardation plate R4 is disposed between the polarizer PL and the first retardation plate R1 in such a manner that its slow axis is set at 0° azimuth. In short, the relationship between the slow axis of the fourth retardation plate R4 and the absorption axis of the polarizer PL is different from that in the second embodiment, and the fourth retardation plate R4 is disposed such that its slow axis is perpendicular to the absorption axis of the polarizer PL.

FIG. 11 shows a structure example of the third embodiment. The structure, other than the fourth retardation plate R4, is the same as the structure example of the second embodiment shown in FIG. 9.

In the third embodiment, the retardation R of the fourth retardation plate R4 is set at, e.g. 275 nm, like the second embodiment, and the Nz coefficient is set at 0.4 or more, and 0.7 or less, so as to establish a reverse relationship. Thereby, the same advantageous effects as the above structure example can be obtained. In this example, the Nz coefficient of the fourth retardation plate R4 is set at, e.g. 0.7.

As regards the third embodiment, the viewing angle dependency of the contrast ratio in the transmissive display was simulated. Like the second embodiment, the contrast ratio=10:1, or more, is obtained in the range of viewing angles of 80° or more in all azimuth directions of the screen, and it was confirmed that sufficient viewing angles can be obtained.

### Fourth Embodiment

Next, a liquid crystal display device according to a fourth embodiment is described. In the fourth embodiment, the first optical element 40 and second optical element 50 have the function of optically compensating the retardation of the liquid crystal layer 30 in a predetermined display state in which a voltage is applied to the liquid crystal layer 30 in the above-described liquid crystal display panel 1. The first optical element 40 and second optical element 50 are configured to have retardation in their thickness direction.

As shown in FIG. 12, the first optical element 40 is disposed on the outer surface of the array substrate 10, and the second optical element 50 is disposed on the outer surface of the counter-substrate 20. The first optical element 40 and second optical element 50 have the same structure. Specifically, each of the first optical element 40 and second optical element 50 is configured to include a circular polarization element C including a polarizer PL and a first retardation plate R1; and a second retardation plate R2. The first optical element 40 and second optical element 50 are configured to be symmetric with respect to the liquid crystal display panel 1. Specifically, in each of the first optical element 40 and second optical element 50, the second retardation plate R2, first retardation plate R1 and polarizer PL are stacked in the named order from the liquid crystal display panel 1 side.

In particular, in this fourth embodiment, the first retardation plate R1, which has biaxial refractive index anisotropy, is applied. Specifically, the first retardation plate R1 has refractive index anisotropy of nx>ny>nz. In the first retardation plate R1, its refractive index anisotropy is so set as to have both functions of a widely used ¼ wavelength plate having uniaxial refractive index anisotropy, and a retardation plate corresponding to a C-plate having retardation in its thickness direction. In short, in the fourth embodiment, the retardation in the thickness direction of the optical element is provided by the first retardation plate R1.

The second retardation plate R2 is the same as that used in the first embodiment, etc.

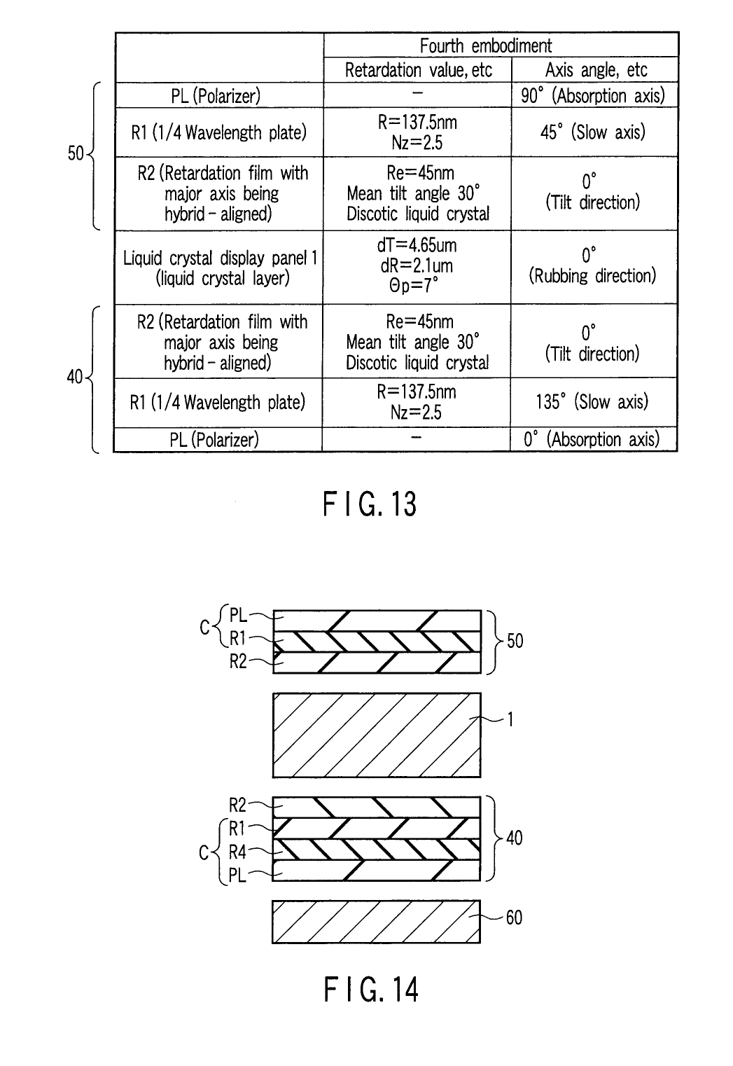

FIG. 13 shows a structure example of the fourth embodiment.

Specifically, the structure of the liquid crystal display panel 1 is the same as that in the first embodiment, etc.

In the array substrate-side first optical element 40, the polarizer PL is disposed such that its absorption axis is set at 0° azimuth. The first retardation plate R1 is disposed such that its slow axis is set at 135° azimuth. The second retardation plate R2 is a retardation plate in which discotic liquid crystal molecules are hybrid-aligned in its thickness direction, and a mean tilt angle of the major axis of the discotic liquid crystal molecule is set at 30° to the normal line. The second retardation plate R2 is disposed such that the comprehensive orthogonal projection of the major axis on the X-Y plane is parallel to the rubbing direction. In short, the tilt angle of the major axis of the second retardation plate R2 is set at 0° azimuth.

In the counter-substrate-side second optical element 50, the polarizer PL is disposed such that its absorption axis is set at 90° azimuth. The first retardation plate R1 is disposed such that its slow axis is set at 45° azimuth. The second retardation plate R2 is disposed such that the tilt angle of its major axis is set at 0° azimuth.

As described above, in the fourth embodiment, in particular, each of the slow axes of the first retardation plates R1 of the first optical element 40 and second optical element 50 is set at 45° to the rubbing direction, and both slow axes are disposed to be perpendicular to each other. Thereby, the effect of wavelength dispersion of the first retardation plate R1 itself can be relaxed. In particular, it becomes possible to suppress a decrease in contrast due to the wavelength dependency when the liquid crystal display device is observed from the front (the normal direction of the liquid crystal display panel).

In addition, each of the polarizers PL, which are included in the first optical element 40 and second optical element 50, is disposed such that the absorption axis thereof is set at 45° to the slow axis of the first retardation plate R1 that constitutes the circular polarization element, and that the absorption axes of both polarizers PL are perpendicular to each other.

The retardation values of the respective structural parts of the first optical element 40 and second optical element 50 are as follows. In this case, the retardation values at the wavelength of 550 nm are indicated. Specifically, the retardation R of the first retardation plate R1 is 137.5 nm, and the Nz coefficient is set at 2.5. The retardation (in-plane retardation) Re of the second retardation plate R2 is 45 nm. In this case, the retardation values are set to be equal between the first optical element 40 and the second optical element 50 which are disposed via the liquid crystal layer 30, but in the present invention these retardation values may not be equal.

Preferably, the Nz coefficient of the first retardation plate R1 should be set at 2.3 or more, and 2.7 or less. The reason is that if the Nz coefficient is less than 2.3, the retardation in the thickness direction becomes too small, and if the Nz coefficient is greater than 2.7, the retardation in the thickness direction becomes too large, and the effect of optical compensation of the liquid crystal layer becomes small.

According to the above-described fourth embodiment, in the OCB mode transflective liquid crystal display device which has the function of effecting reflective display by the reflective part and transmissive display by the transmissive part, the comprehensive optical design of the optical element, which includes the circular polarization element, and the OCB mode liquid crystal display panel is optimized, while the number of parts of the optical element is decreased. Therefore, the cost can be reduced, the display with a high contrast ratio can be realized both in reflective display and transmissive display in the case of not only observation in a frontal direction but also observation in an oblique direction, and the viewing angle, at which the high contrast ratio can be obtained, can be increased.

### Fifth Embodiment

Next, a liquid crystal display device according to a fifth embodiment is described. In the fifth embodiment, like the fourth embodiment, the first optical element 40 and second optical element 50 have the function of optically compensating the retardation of the liquid crystal layer 30 in a predetermined display state in which a voltage is applied to the liquid crystal layer 30 in the above-described liquid crystal display panel 1. In particular, in this fifth embodiment, the circular polarization element C, which is provided in one of the first optical element 40 and second optical element 50, includes a fourth retardation plate R4 which is disposed between the polarizer PL and the first retardation plate R1. Thus, the first optical element 40 and second optical element 50 are asymmetric with respect to the liquid crystal display panel 1.

In an example shown in FIG. 14, the circular polarization element C of the first optical element 40, which is disposed on the array substrate 10 side of the liquid crystal display panel 1, includes the polarizer PL, fourth retardation plate R4 and first retardation plate R1. However, the circular polarization element C of the second optical element 50 may include the fourth retardation plate R4. The other structure is the same as that of the fourth embodiment.

The fourth retardation plate R4 has a fast axis and a slow axis which are substantially perpendicular to each other, and is a so-called ½ wavelength plate which imparts a retardation of ½ wavelength between light components of a predetermined wavelength (e.g. light having a wavelength of 550 nm) which pass through the fast axis and the slow axis. The fourth retardation plate R4 has a function of compensating the viewing angle dependency of the retardation of the entire liquid crystal display device, and increasing the viewing angle. In particular, the fourth retardation plate R4 is configured to mainly compensate the viewing angle dependency of the retardation of the ¼ wavelength plate (first retardation plate R1) of the circular polarization element C, which is needed in the OCB mode transflective liquid crystal display device. Needless to say, there is a case in which structural parts, other than the first retardation plate R1, have viewing angle dependency, and these complex factors can be thought to cause a decrease in viewing angle.

Thus, in the fifth embodiment, the fourth retardation plate R4 is disposed so that when transmissive display is executed, such a retardation may be imparted as to achieve polarization close to ideal circular polarization even in the case where observation is performed in an oblique direction, thereby to compensate the viewing angle dependency of the retardation of not only the first retardation plate R1 but also the entire liquid crystal display device. Thereby, the viewing angle, at which a high contrast ratio can be obtained, can be made still wider than in the fourth embodiment.

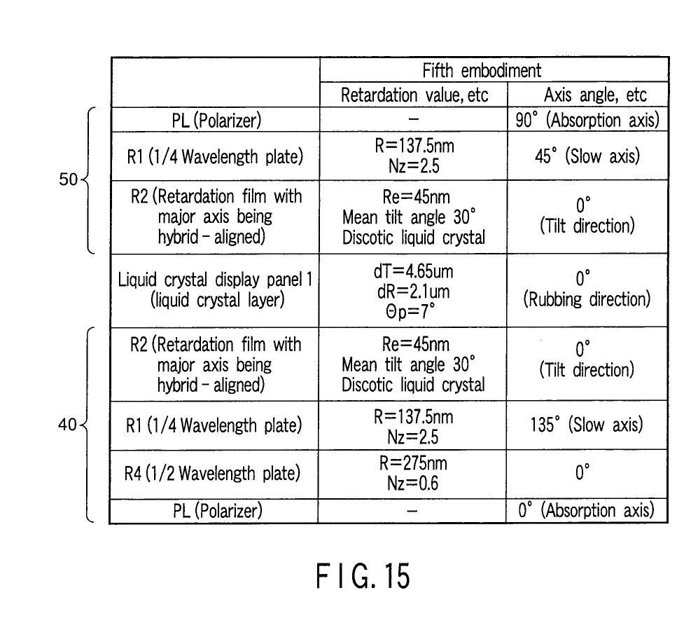

FIG. 15 shows a structure example of the fifth embodiment. The structure, other than the fourth retardation plate R4, is the same as the structure example of the fourth embodiment shown in FIG. 13.

In this structure example, the fourth retardation plate R4, which has biaxial refractive index anisotropy, is applied. Specifically, the fourth retardation plate R4 has refractive index anisotropy of nx>ny>nz. In the first optical element 40, the fourth retardation plate R4 is disposed such that its slow axis is set at 0° azimuth. In short, the slow axis of the fourth retardation plate R4 is set to be parallel to the absorption axis of the polarizer PL.

Thus, in the frontal direction, there is no influence of the retardation of the fourth retardation plate R4, and good display with a high contrast is observed as in the fourth embodiment. In the case where observation is performed in an oblique direction, the retardation, which is possessed by the fourth retardation plate R4, effectively functions, the viewing angle dependency of the retardation of the entire liquid crystal display device can be compensated, and polarization close to ideal circular polarization can be achieved. Therefore, good display with a high contrast can be observed in a wide range of viewing angles.

The retardation values of the respective structural parts of the first optical element 40 and second optical element 50 are as shown in FIG. 15. Like the fourth embodiment, the retardation values at the wavelength of 550 nm are shown. The fourth retardation plate R4 has a retardation R of 275 nm, and the Nz coefficient is set at 0.6.

Preferably, the Nz coefficient of the fourth retardation plate R4 should be set at 0.5 or more, in particular, in order to impart such a retardation as to achieve polarization close to ideal circular polarization also with respect to viewing angles of 60° or more in the azimuth directions of 45°-225° and 135°-315°. In addition, in order to prevent over-compensation which causes polarization exceeding the ideal circular polarization, it is preferable to set the Nz coefficient of the fourth retardation plate R4 at 0.7 or less.

According to the above-described fifth embodiment, in the OCB mode transflective liquid crystal display device which has the function of effecting reflective display by the reflective part and transmissive display by the transmissive part, the comprehensive optical design of the optical element, which includes the circular polarization element, and the OCB mode liquid crystal display panel can be more optimized than in the fourth embodiment, while the number of parts of the optical element is decreased. Therefore, the cost can be reduced, the display with a high contrast ratio can be realized both in reflective display and transmissive display in the case of not only observation in a frontal direction but also observation in an oblique direction, and the viewing angle, at which the high contrast ratio can be obtained, can be increased.

The present invention is not limited directly to the above-described embodiments. In practice, the structural elements can be modified and embodied without departing from the spirit of the invention. Various inventions can be made by properly combining the structural elements disclosed in the embodiments. For example, some structural elements may be omitted from all the structural elements disclosed in the embodiments. Furthermore, structural elements in different embodiments may properly be combined.

For example, it should suffice if the above-described first optical element 40 and second optical element 50 are disposed on the outside of the liquid crystal layer 30. Specifically, the first optical element 40 is not limited to the structures of the above-described embodiments, and at least one of the first retardation plate R1, third retardation plate R3 and second retardation plate R2, which constitute the first optical element 40, may be disposed between the insulating substrate 11, which constitutes the array substrate 10, and the liquid crystal layer 30. In addition, the second optical element 50 is not limited to the structures of the above-described embodiments, and at least one of the first retardation plate R1, third retardation plate R3 and second retardation plate R2, which constitute the second optical element 50, may be disposed between the insulating substrate 21, which constitutes the counter-substrate 20, and the liquid crystal layer 30.

In the first to third embodiments, the third retardation plate R3 is formed of a single optically negative C-plate, but the third retardation plate R3 may be formed of two A-plates which are disposed such that their slow axes are perpendicular to each other.

Furthermore, in each of the above-described embodiments, the retardation Rth of the third retardation plate R3 is optimized such that the retardation in the transmissive part is canceled in the case where main display is performed in the transmissive part, that is, in the case where the area of the transmissive part is greater than the area of the reflective part (e.g. the area of the transmissive part is four times larger than the area of the reflective part). However, in the case where main display is performed in the reflective part, that is, in the case where the area of the reflective part is greater than the area of the transmissive part, the retardation Rth of the third retardation plate R3, which constitutes the second optical element 50, may be optimized such that the retardation in the reflective part is canceled. Besides, the retardation Rth of the third retardation plate R3, which constitutes the second optical element 50, may be set to be optimized in the reflective part, while the retardation Rth of the third retardation plate R3, which constitutes the first optical element 40, may be optimized such that the retardation in the transmissive part is also canceled in cooperation with the third retardation plate on the second optical element side.

1. A liquid crystal display device having a reflective part and a transmissive part in each of a plurality of pixels which are arrayed in a matrix, comprising:
a liquid crystal display panel which is configured such that a liquid crystal layer is held between a pair of substrates, and to which an OCB mode is applied; and
a pair of optical elements which are disposed on outsides of the liquid crystal layer, respectively, and optically compensate a retardation of the liquid crystal layer in a predetermined display state in which a voltage is applied to the liquid crystal layer,
wherein the optical element is configured to include:
a circular polarization element including a polarizer and a first retardation plate which is disposed between the polarizer and the liquid crystal display panel and imparts a retardation of ¼ wavelength; and
a second retardation plate which is disposed between the circular polarization element and the liquid crystal layer, and has refractive index anisotropy with a major axis being inclined to a normal line, and
the optical element has a retardation in a thickness direction thereof.

2. The liquid crystal display device according to claim 1, wherein the optical element further includes a third retardation plate which is disposed between the circular polarization element and the second retardation plate, and performs C-plate function having uniaxial refractive index anisotropy, and a retardation in the thickness direction is imparted.

3. The liquid crystal display device according to claim 2, wherein the circular polarization element, which is provided in one of the optical elements, includes a fourth retardation plate which is disposed between the polarizer and the first retardation plate, and imparts a retardation of ½ wavelength.

4. The liquid crystal display device according to claim 3, wherein the fourth retardation plate has biaxial refractive index anisotropy, is disposed such that a slow axis thereof is parallel to an absorption axis of the polarizer, and has an Nz coefficient which is set at 0.3 or more, and 0.6 or less, the Nz coefficient being given by Nz=(nx−nz)/(nx−ny), where nx and ny are refractive indices in mutually perpendicular directions in a plane thereof, and nz is a refractive index in a thickness direction thereof.

5. The liquid crystal display device according to claim 3, wherein the fourth retardation plate has biaxial refractive index anisotropy, is disposed such that a slow axis thereof is perpendicular to an absorption axis of the polarizer, and has an Nz coefficient which is set at 0.4 or more, and 0.7 or less, the Nz coefficient being given by Nz=(nx−nz)/(nx−ny), where nx and ny are refractive indices in mutually perpendicular directions in a plane thereof, and nz is a refractive index in a thickness direction thereof.

6. The liquid crystal display device according to claim 3, wherein the fourth retardation plate is provided in the circular polarization element of the optical element which is disposed on an observation surface side.

7. The liquid crystal display device according to claim 1, wherein the first retardation plate has biaxial refractive index anisotropy, and to which a retardation in the thickness direction is imparted.

8. The liquid crystal display device according to claim 7, wherein the first retardation plate has an Nz coefficient which is set at or 2.3 or more, and 2.7 or less, the Nz coefficient being given by Nz=(nx−nz)/(nx−ny), where nx and ny are refractive indices in mutually perpendicular directions in a plane thereof, and nz is a refractive index in a thickness direction thereof.

9. The liquid crystal display device according to claim 7, wherein the circular polarization element, which is provided in one of the optical elements, includes a fourth retardation plate which is disposed between the polarizer and the first retardation plate, and imparts a retardation of ½ wavelength.

10. The liquid crystal display device according to claim 9, wherein the fourth retardation plate has biaxial refractive index anisotropy, is disposed such that a slow axis thereof is parallel to an absorption axis of the polarizer, and has an Nz coefficient which is set at 0.5 or more, and 0.7 or less, the Nz coefficient being given by Nz=(nx−nz)/(nx−ny), where nx and ny are refractive indices in mutually perpendicular directions in a plane thereof, and nz is a refractive index in a thickness direction thereof.

11. The liquid crystal display device according to claim 1, wherein the first retardation plate is disposed such that a slow axis thereof is set at about 45° to a rubbing direction of the liquid crystal layer.

12. The liquid crystal display device according to claim 1, wherein a cell gap dR of the reflective part is set at
dR<dT/2
in relation to a cell gap dT of the transmissive part.
